(19) United States
(12) Patent Application Publication
(10) Pub. No.: US 2025/0181304 A1
(43) Pub. Date: Jun. 5, 2025

(54) SOUND REPRODUCING APPARATUS, SOUND REPRODUCING METHOD, AND SOUND REPRODUCING PROGRAM

(71) Applicant: NIPPON TELEGRAPH AND TELEPHONE CORPORATION, Tokyo (JP)

(72) Inventors: Taisuke WAKASUGI, Tokyo (JP); Masashi TADOKORO, Tokyo (JP); Hideaki TANAKA, Tokyo (JP)

(73) Assignee: NIPPON TELEGRAPH AND TELEPHONE CORPORATION, Tokyo (JP)

(21) Appl. No.: 18/843,240

(22) PCT Filed: Mar. 2, 2022
(86) PCT No.: PCT/JP2022/008996

§ 371 Date: Aug. 31, 2024

(51) Int. Cl. G06F 3/16; G06F 21/60

(52) U.S. Cl. CPC G06F 3/165; G06F 21/602

(57) ABSTRACT

A sound reproduction device (10) includes an acquisition unit (15a) that acquires display information displayed as a user interface (UI) component, a specifying unit (15b) that specifies target information related to a target to be reproduced as sound on the basis of identification information indicated by the display information, and a reproduction unit (15d) that reproduces the target information as sound.

### TECHNICAL FIELD

The present invention relates to a sound reproduction device, a sound reproduction method, and a sound reproduction program.

### BACKGROUND ART

Conventionally, there has been a user interface (UI) extension technology that improves productivity of an operator by overlaying a function extension such as a text input box or an input check on a web screen without modifying a system (for example, see Patent Literature 1).

### CITATION LIST

### Patent Literature

Patent Literature 1: JP 2017-072872 A

### SUMMARY OF INVENTION

### Technical Problem

However, in the existing technology, effective use of the UI extension technology is difficult. For example, in the existing technology, in a case where confidential information is included in a UI component displayed by the UI extension technology, there is a risk that the confidential information is leaked to an unspecified number of people other than a browsing authority person when the UI component having personal information is displayed on a monitor, from the viewpoint of personal information protection, in-house confidential information, and the like. Further, in the existing technology, it is difficult to operate an appropriate system for a person who cannot use a display device such as a monitor or smart glasses, or in an environment or at a place where the display device cannot be used, such as at the time of dealing with a customer or for a person with visual disability.

The present invention has been made in view of the foregoing, and an object of the present invention is to provide a sound reproduction device, a sound reproduction method, and a sound reproduction program that enable effective use of a UI extension technology.

### SOLUTION TO PROBLEM

To solve the above-described problems and achieve the object, a sound reproduction device according to the present invention includes: an acquisition unit that acquires display information displayed as a UI component; a specifying unit that specifies target information related to a target to be reproduced as sound on the basis of identification information indicated by the display information; and a reproduction unit that reproduces the target information as sound.

Further, a sound reproduction method according to the present invention is a sound reproduction method executed by a sound reproduction device, the sound reproduction method including: an acquisition step of acquiring display information displayed as a UI component; a specifying step of specifying target information related to a target to be reproduced as sound on the basis of identification information indicated by the display information; and a reproduction step of reproducing the target information as sound.

Further, a sound reproduction program according to the present invention causes a computer to execute: an acquisition procedure of acquiring display information displayed as a UI component; a specifying procedure of specifying target information related to a target to be reproduced as sound on the basis of identification information indicated by the display information; and a reproduction procedure of reproducing the target information as sound.

### ADVANTAGEOUS EFFECTS OF INVENTION

The present invention enables effective use of a UI extension technology.

### BRIEF DESCRIPTION OF DRAWINGS

FIG. 1 is a diagram illustrating a configuration example of a sound reproduction system according to a first embodiment.

FIG. 2 is a block diagram illustrating a configuration example of each device of the sound reproduction system according to the first embodiment.

FIG. 3 is a flowchart illustrating an example of a flow of sound reproduction processing 1 of a personal terminal according to the first embodiment.

FIG. 4 is a flowchart illustrating an example of a flow of sound reproduction processing 2 of the personal terminal according to the first embodiment.

FIG. 5 is a flowchart illustrating an example of a flow of sound reproduction processing 3 of the personal terminal according to the first embodiment.

FIG. 6 is a flowchart illustrating an example of a flow of ID marker display processing of a work terminal according to the first embodiment.

FIG. 7 is a flowchart illustrating an example of a flow of selection information reflection processing of a work terminal according to the first embodiment.

FIG. 8 is a diagram illustrating a computer that executes a program.

### DESCRIPTION OF EMBODIMENTS

Hereinafter, embodiments of a sound reproduction device, a sound reproduction method, and a sound reproduction program according to the present invention will be described in detail with reference to the drawings. Note that the present invention is not limited to the embodiments described below.

### First Embodiment

Hereinafter, a configuration of a sound reproduction system 100, a configuration of each device of the sound reproduction system 100, and a flow of each processing according to a first embodiment will be sequentially described, and finally, effects of the first embodiment will be described.

### 1. Configuration of Sound Reproduction System 100

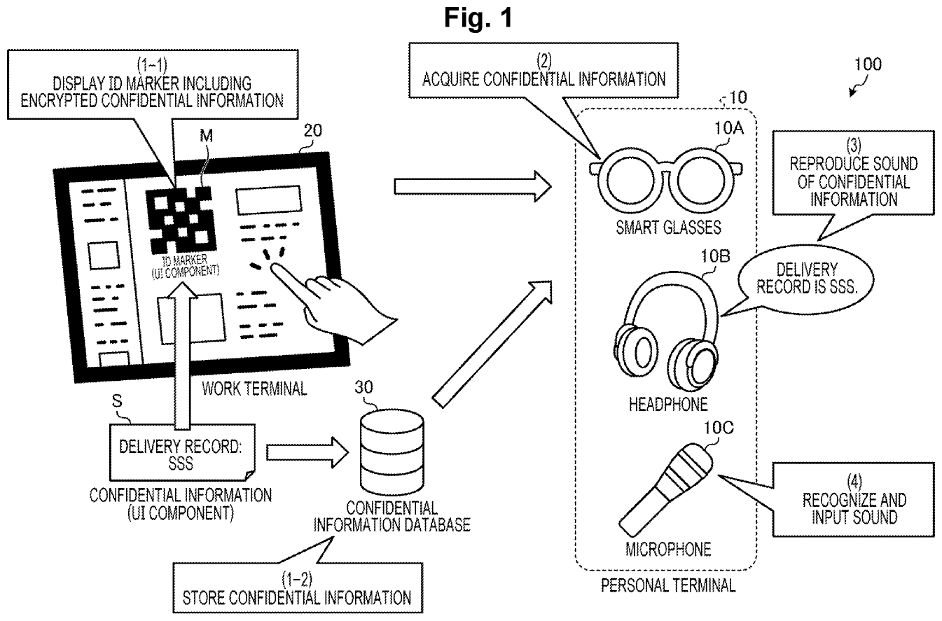

A configuration of the sound reproduction system 100 according to the first embodiment will be described in detail with reference to FIG. 1. FIG. 1 is a diagram illustrating a configuration example of the sound reproduction system according to the first embodiment. Hereinafter, each processing will be described with a configuration example of the entire sound reproduction system 100.

### 1-1. Configuration Example of Entire Sound Reproduction System 100

As illustrated in FIG. 1, the sound reproduction system 100 includes a personal terminal 10 (smart glasses 10A, a headphone 10B, or a microphone 10C) that is a sound reproduction device, a work terminal 20, and a confidential information database 30. Here, the personal terminal 10, the work terminal 20, and the confidential information database 30 are communicably connected by wire or wirelessly via a predetermined communication network (not illustrated). Note that the sound reproduction system 100 illustrated in FIG. 1 may include a plurality of the personal terminals 10, a plurality of the work terminals 20, or a plurality of the confidential information databases 30.

### 1-1-1. Personal Terminal 10

The personal terminal 10 is a device (computer) that executes sound reproduction on the basis of information acquired from the work terminal 20. The personal terminal 10 receives an operation by a user of the personal terminal 10. Note that the personal terminal 10 is implemented by, for example, the smart glasses 10A, the headphone 10B, the microphone 10C, a tablet terminal, a notebook personal computer (PC), a desktop PC, a mobile phone, a personal digital assistant (PDA), or the like. In the example of FIG. 1, a case where the personal terminal 10 is implemented by the smart glasses 10A, the headphone 10B, and the microphone 10C is illustrated. In the example of FIG. 1, the personal terminal 10 is physically separated into the smart glasses 10A, the headphone 10B, and the microphone 10C. However, two or more of the above terminals may be integrated. That is, the personal terminal 10 may have a configuration in which the smart glasses 10A include the headphone 10B that executes sound output processing and the microphone 10C that executes sound input processing.

### 1-1-2. Work Terminal 20

The work terminal 20 is a device (computer) that displays an ID marker M read by the personal terminal 10. The work terminal 20 receives an operation by an operator of the work terminal 20. Note that the work terminal 20 is implemented by, for example, a smartphone, a tablet terminal, a notebook personal computer (PC), a desktop PC, a mobile phone, a personal digital assistant (PDA), or the like. In the example of FIG. 1, a case where the work terminal 20 is implemented by a tablet terminal is illustrated.

1-1-3. Confidential Information Database 30 The confidential information database 30 is a storage device that stores confidential information to be described below. The confidential information database 30 may store the confidential information as a part of the work terminal 20.

### 1-2. Processing of Sound Reproduction System 100

Hereinafter, ID marker display processing, confidential information acquisition processing, sound information output processing, and sound information input processing will be described as processing of the sound reproduction system 100. Note that the pieces of following processing can be executed in a different order. In addition, there may be omitted processing among the pieces of following processing.

### 1-2-1. ID Marker Display Processing

First, the work terminal 20 displays the ID marker M on a screen. Here, the ID marker M is a UI component displayed by a UI extension technology, and is, for example, a predetermined code including identification information (ID information) of confidential information S acquired by the personal terminal 10 or the confidential information S itself. Further, the ID marker M may be not only a two-dimensional code such as a QR code (registered trademark) but also a barcode, a predetermined mark, a number, or the like. In the example of FIG. 1, the ID marker display processing using a QR code (registered trademark) will be described, but the embodiment is not particularly limited.

The work terminal 20 encrypts the confidential information S and displays the ID marker M including the confidential information S on the screen (see FIG. 1 (1-1)). At this time, the work terminal 20 may acquire the confidential information S encrypted by a terminal other than the work terminal 20, or may acquire the encrypted confidential information S stored in the confidential information database 30.

Meanwhile, the work terminal 20 can store the confidential information S in the confidential information database 30, and display the ID marker M indicating coordinates and the like of the confidential information S on the screen (see FIG. 1 (1-2)). At this time, the work terminal 20 may store the confidential information S using a storage unit (not illustrated) included in the work terminal 20. The work terminal 20 may store the encrypted confidential information S in the confidential information database 30.

### 1-2-2. Confidential Information Acquisition Processing

Secondly, the personal terminal 10 acquires the confidential information S (see FIG. 1 (2)). Here, the confidential information is, for example, secret information such as credibility information, personal information, and know-how information, and is information that is not desirably displayed on an appropriate UI component in a public space, a home environment, or the like. In the example of FIG. 1, the personal terminal 10 acquires “delivery record: SSS” as the confidential information S related to credibility information.

In the case where the ID marker M is displayed by the processing of FIG. 1 (1-1), that is, in the case where the ID marker M including the encrypted confidential information S is displayed, the personal terminal 10 acquires the confidential information S as follows. For example, the personal terminal 10 reads the ID marker M on the screen of the work terminal 20 with the smart glasses 10A, specifies an ID of the ID marker M, decrypts decryption information that is the encrypted confidential information S, and acquires the confidential information S corresponding to the ID marker M.

Meanwhile, in the case where the ID marker M is displayed by the processing of FIG. 1 (1-2), that is, in the case where the ID marker M indicating the coordinates and the like of the confidential information S in the confidential information database 30 is displayed, the personal terminal 10 acquires the confidential information S as follows. For example, the personal terminal 10 reads the ID marker M on the screen of the work terminal 20 with the smart glasses 10A, specifies the ID of the ID marker M, specifies the coordinates of the confidential information S in the confidential information database 30, and acquires the confidential information S corresponding to the ID marker M from the confidential information database 30.

### 1-2-3. Sound Information Output Processing

Thirdly, the personal terminal 10 reproduces the acquired confidential information S as sound (see FIG. 1 (3)). For example, the personal terminal 10 reproduces the confidential information S having the corresponding ID marker M displayed on the screen of the work terminal 20 as sound by the headphone 10B. In the example of FIG. 1, the personal terminal 10 executes sound reproduction of “Delivery record is SSS.” as the confidential information S. At this time, the personal terminal 10 may display the confidential information S of image data, moving image data, and text data using the smart glasses 10A in addition to the sound data, or may reproduce the confidential information S by light or vibration using a terminal (not illustrated).

### 1-2-4. Sound Information Input Processing

Fourthly, the personal terminal 10 inputs a sound reply to the acquired confidential information S to the work terminal 20 (see FIG. 1 (4)). For example, in a case where the confidential information S is a question in a selection format such as “Please input customer's reaction. 1. affirmative, 2. neutral, 3. negative”, the personal terminal 10 receives a sound input of “3” of the user using the microphone 10C, recognizes the sound, and reflects the input as a reply to the work terminal 20.

(1-3. Effects of Sound Reproduction System 100) Hereinafter, problems of the UI extension technology as a reference technology will be described, and then effects of the sound reproduction system 100 will be described in detail.

### 1-3-1. Problems

The UI extension technology is a technology that improves productivity of an operator by overlaying a function extension such as a text input box or an input check on a web screen without modifying a system, but there are the following three problems.

As a first problem, in the above technology, in a case where confidential information is included in a UI component displayed by the UI extension technology, there is a risk that the confidential information is leaked to an unspecified number of people other than a browsing authority person when the UI component having personal information is displayed on a monitor, from the viewpoint of personal information protection, in-house confidential information, and the like.

As a second problem, in the above technology, it is difficult to operate the appropriate system for a person who cannot use a display device such as a monitor or smart glasses, or in an environment or at a place where the display device cannot be used, such as at the time of dealing with a customer or for a person with visual disability.

As a third problem, in the above technology, in a case where information is reflected to the UI component or a terminal, when an input device such as a monitor or a keyboard is used, there is a possibility that selection information is leaked from a screen or an operation to an unspecified number of people other than a browsing authority person. In addition, in the above technology, it is difficult to operate the appropriate system in an environment or situation where there is no input device such as a monitor or a keyboard or where the input device cannot be used.

### 1-3-2. Overview

In the sound reproduction system 100, the personal terminal 10 acquires the ID marker M displayed as the UI component, specifies the confidential information S to be reproduced as sound on the basis of ID information indicated by the ID marker M, and reproduces the confidential information S as sound. At this time, the personal terminal 10 acquires the ID marker M including the encrypted confidential information S, decrypts the encrypted confidential information S, and reproduces the decrypted confidential information S as sound. In addition, the personal terminal 10 specifies a storage area for storing the confidential information S on the basis of the ID information indicated by the ID marker M, and reproduces the confidential information S stored in the specified storage area as sound. That is, in the sound reproduction system 100, the personal terminal 10 acquires information not displayed on a monitor from a database or the like by reading the ID marker M of the UI component using a reading device such as the smart glasses 10A or a camera, can read out corresponding information using the sound reproduction device such as a headphone.

In addition, in the sound reproduction system 100, the personal terminal 10 reflects a sound reply to the reproduced confidential information S on the UI component. That is, in the sound reproduction system 100, the personal terminal 10 can reflect information on the UI component or a terminal while maintaining confidentiality using an input device of sound recognition.

### 1-3-3. Effects

Therefore, the sound reproduction system 100 contributes to solving the above-described problems of the UI extension technology. That is, in the sound reproduction system 100, the work terminal 20 displays the ID marker M obtained by encrypting the confidential information S on the appropriate screen or portion later, the personal terminal 10 including the smart glasses 10A or the reading device such as a camera acquires and decrypts the ID marker M using an arbitrary information acquisition means of image recognition or the like, and the sound reproduction device such as the headphone 10B reproduces the sound, thereby contributing to solving the above-described first and second problems.

In addition, in the sound reproduction system 100, the work terminal 20 displays the ID marker M associated with an arbitrary display rule file stored in a storage unit in the work terminal 20 or in the external confidential information database 30 as a UI component on the appropriate screen or portion, and the personal terminal 10 including the smart glasses 10A or the reading device such as a camera acquires the ID information using an arbitrary ID identification means of image recognition or the like, and collates rule file information associated with the ID with the work terminal 20, the confidential information database 30, or the storage unit in the personal terminal 10 such as the smart glasses 10A and reproduces the sound, thereby contributing to solving the above-described first and second problems.

In addition, in a case where information that needs to be selected is included in the sound information to be reproduced, the sound reproduction system 100 makes a selection by using an arbitrary sound recognition means using an input device such as the microphone 10C or the smart glasses 10A, and reflects the selected selection information on the work terminal 20, thereby contributing to solving the above-described third problem.

As described above, the sound reproduction system 100 is a system in which information displayed on the work terminal 20 is separated as necessary by the UI extension technology, specific information can be recognized as sound only by a specific person, and the other people cannot recognize the confidential information S. Furthermore, the sound reproduction system 100 can perform the above setting later due to the characteristics of the UI extension technology. Therefore, the sound reproduction system 100 can effectively use the UI extension technology by using the ID marker M including the encrypted confidential information S and the ID marker M capable of specifying the storage area for storing the confidential information S.

### 2. Configuration of Each Device of Sound Reproduction System 100

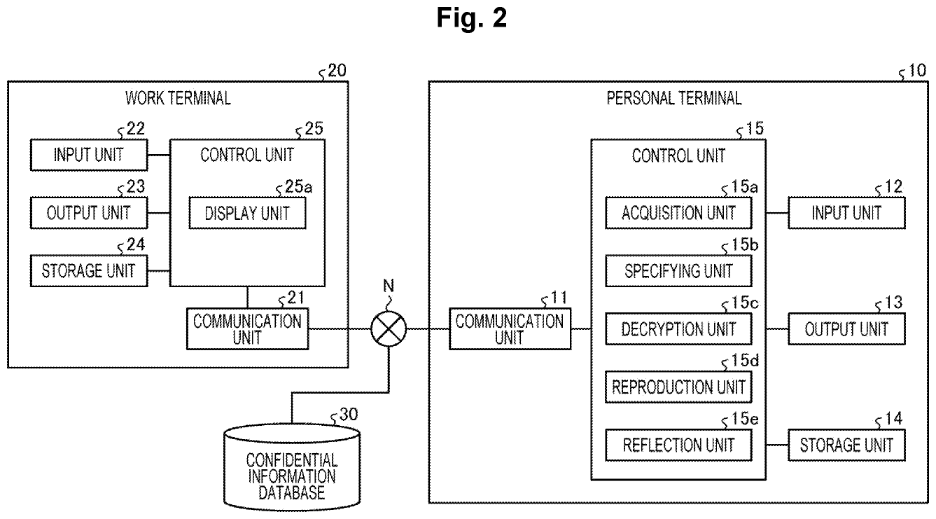

A configuration example of the personal terminal 10, the work terminal 20, and the confidential information database 30 according to the first embodiment will be described in detail with reference to FIG. 2. FIG. 2 is a block diagram illustrating a configuration example of each device of the sound reproduction system according to the first embodiment.

### 2-1. Configuration Example of Personal Terminal 10

A configuration example of the personal terminal 10 according to the first embodiment will be described in detail with reference to FIG. 2. The personal terminal 10 includes a communication unit 11, an input unit 12, an output unit 13, a storage unit 14, and a control unit 15.

### 2-1-1. Communication Unit 11

The communication unit 11 is implemented by using, for example, a network interface card (NIC) or the like. Then, the communication unit 11 is connected to a predetermined communication network (network) N in a wired or wireless manner, and transmits and receives information to and from various devices.

2-1-2. Input Unit 12 The input unit 12 is implemented by, for example, the smart glasses 10A, a camera, the microphone 10C, a keyboard, a mouse, or the like. Then, the input unit 12 receives various operations from the user of the personal terminal 10.

### 2-1-3. Output Unit 13

The output unit 13 is implemented by, for example, the headphone 10B, the smart glasses 10A, a liquid crystal display, or the like. Then, the output unit 13 displays various types of information.

### 2-1-4. Storage Unit 14

The storage unit 14 is implemented by, for example, a semiconductor memory element such as a random access memory (RAM) or a flash memory, or a storage device such as a hard disk or an optical disk. Then, the storage unit 14 stores various types of information referred to when the control unit 15 operates and various types of information acquired when the control unit 15 has operated. For example, the storage unit 14 stores the confidential information acquired from the work terminal 20 or the confidential information database 30.

### 2-1-5. Control Unit 15

The control unit 15 controls the entire personal terminal 10. The control unit 15 includes an acquisition unit 15a, a specifying unit 15b, a decryption unit 15c, a reproduction unit 15d, and a reflection unit 15e. Here, the control unit 15 is, for example, an electronic circuit such as a central processing unit (CPU) or a micro processing unit (MPU), or an integrated circuit such as an application specific integrated circuit (ASIC) or a field programmable gate array (FPGA).

### 2-1-5-1. Acquisition Unit 15a

The acquisition unit 15a acquires display information displayed as a UI component. For example, the acquisition unit 15a acquires display information including encrypted target information. Description is given with a specific example. The acquisition unit 15a acquires an image of a two-dimensional code of the ID marker M including the encrypted confidential information. In addition, the acquisition unit 15a acquires an image of a two-dimensional code of the ID marker M indicating the coordinates that are position information of the confidential information S stored in the confidential information database 30.

### 2-1-5-2. Specifying Unit 15b

The specifying unit 15b specifies the target information related to a target to be reproduced as sound on the basis of the identification information indicated by the display information. For example, the specifying unit 15b specifies the storage area for storing the target information on the basis of the identification information indicated by the display information. Description is given with a specific example. The specifying unit 15b specifies the coordinates that are the position information indicated by the ID information of the ID marker M, and specifies the confidential information database 30 that stores the confidential information S corresponding to the ID information.

### 2-1-5-3. Decryption Unit 15c

The decryption unit 15c decrypts the encrypted target information. For example, the decryption unit 15c decrypts the decryption information that is the encrypted confidential information S included in the ID marker M, and outputs the confidential information S.

### 2-1-5-4. Reproduction Unit 15d

The reproduction unit 15d reproduces the target information as sound. For example, the reproduction unit 15d reproduces the target information decrypted by the decryption unit 15c as sound. Description is given with a specific example. The reproduction unit 15d reproduces the confidential information S decrypted from the decryption information by the decryption unit 15c as sound. Further, the reproduction unit 15d acquires the confidential information S corresponding to the ID information of the ID marker M from the confidential information database 30 specified by the specifying unit 15b, and reproduces the confidential information S as sound.

### 2-1-5-5. Reflection Unit 15e

The reflection unit 15e reflects a sound reply to the target information on the UI component. For example, the reflection unit 15e transmits sound information input via the microphone 10C to the work terminal 20, and reflects the sound information as a reply to the selection information of the confidential information S.

2-2. Configuration Example of Work Terminal 20 A configuration example of the work terminal 20 according to the first embodiment will be described in detail with reference to FIG. 2. The work terminal 20 includes a communication unit 21, an input unit 22, an output unit 23, a storage unit 24, and a control unit 25.

### 2-2-1. Communication Unit 21

The communication unit 21 is implemented by, for example, an NIC or the like. Then, the communication unit 21 is connected to a predetermined communication network (network) N in a wired or wireless manner, and transmits and receives information to and from various devices.

### 2-2-2. Input Unit 22

The input unit 22 is implemented by, for example, a keyboard, a mouse, a button for inputting characters, numbers, and the like. Note that the input unit 22 may be an input/output port (I/O port), a universal serial bus (USB) port, or the like. Furthermore, in a case where the output unit 23 is a touch panel-type display, a part of the output unit 23 functions as the input unit 22. Furthermore, the input unit 22 may be a microphone or the like that receives a sound input from the operator of the work terminal 20. The microphone may be wireless. Then, the input unit 22 receives various operations from the operator of the work terminal 20.

### 2-2-3. Output Unit 23

The output unit 23 is implemented by, for example, a liquid crystal display (LCD) or an organic electro-luminescent display (organic EL display). In addition, the output unit 23 is a touch panel-type display, but is not limited thereto. Then, the output unit 23 displays various types of information.

### 2-2-4. Storage Unit 24

The storage unit 24 is implemented by, for example, a semiconductor memory element such as a RAM or a flash memory, or a storage device such as a hard disk or an optical disk. Then, the storage unit 24 stores various types of information that is referred to when the control unit 25 operates and various types of information acquired when the control unit 25 has operated. The storage unit 24 stores the ID marker M, a display rule file, and the like.

### 2-2-5. Control Unit 25

The control unit 25 controls the entire work terminal 20. The control unit 25 includes a display unit 25a. Here, the control unit 25 is, for example, an electronic circuit such as a CPU or an MPU, or an integrated circuit such as an ASIC or an FPGA.

### 2-2-5-1. Display Unit 25a

The display unit 25a displays the display information displayed as a UI component on the output unit 23. For example, the display unit 25a displays the image of the two-dimensional code of the ID marker M including the encrypted confidential information on the output unit 23. In addition, the display unit 25a displays, on the output unit 23, the image of the two-dimensional code of the ID marker M indicating the coordinates that are the position information of the confidential information S stored in the confidential information database 30. At this time, the display unit 25a displays the ID marker M on the output unit 23 on the basis of the display rule file associated with the ID marker M stored in the storage unit 24.

### 2-3. Configuration Example of Confidential Information Database 30

A configuration example of the confidential information database 30 according to the first embodiment will be described in detail with reference to FIG. 2. The confidential information database 30 stores the target information regarding the target to be reproduced as sound. For example, the confidential information database 30 stores the confidential information associated with the ID information of the ID marker M. Further, the confidential information database 30 stores the display rule file associated with the ID information of the ID marker M.

### 3. Flow of Processing of Sound Reproduction System 100

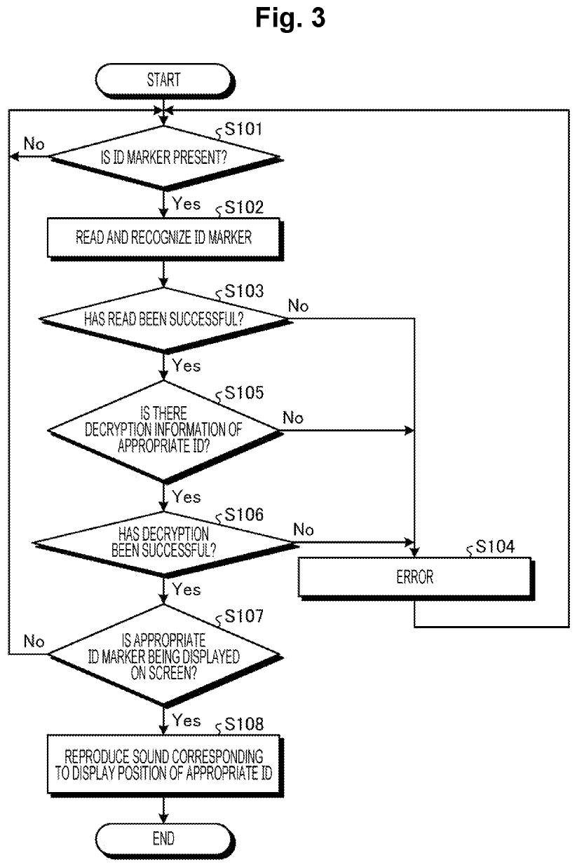

A flow of processing of the sound reproduction system 100 according to the first embodiment will be described with reference to FIGS. 3 to 7. Hereinafter, a flow of processing of the personal terminal 10 of the sound reproduction system 100 and a flow of processing of the work terminal 20 will be described in this order.

### 3-1. Flow of Processing of Personal Terminal 10

A flow of processing of the personal terminal 10 in the sound reproduction system 100 will be described with reference to FIGS. 3 to 5. FIGS. 3 to 5 are flowcharts illustrating an example of flows of sound reproduction processing of the personal terminal 10 according to the first embodiment. Hereinafter, the flow of sound reproduction processing 1, the flow of sound reproduction processing 2, and the flow of sound reproduction processing 3 will be described in this order.

### 3-1-1. Flow of Sound Reproduction Processing 1

The flow of the sound reproduction processing 1 of the personal terminal 10 in the sound reproduction system 100 will be described with reference to FIG. 3. Here, the sound reproduction processing 1 of the personal terminal 10 is processing of reading the ID marker M including the encrypted confidential information S (decryption information), decrypting the decryption information, and then executing sound reproduction. Note that steps S101 to S108 below can be executed in different orders. Furthermore, there may be omitted processing among steps S101 to S108 below.

In a case where the ID marker M is present on the screen of the work terminal 20 (step S101: Yes), the personal terminal 10 reads the ID marker M, executes image recognition processing (step S102), and proceeds to the processing of step S103. On the other hand, in a case where there is no ID marker M on the screen of the work terminal 20 (step S101: No), the personal terminal 10 repeats the processing of step S101.

In a case where the read of the ID marker M has been successful (step S103: Yes), the personal terminal 10 proceeds to the processing of step S105. On the other hand, in a case where the read of the ID marker M has failed (step S103: No), the personal terminal 10 notifies an error (step S104), and returns to the processing of step S101.

In a case where there is the decryption information of the appropriate ID (step S105: Yes), the personal terminal 10 proceeds to the processing of step S106. On the other hand, in a case where there is no decryption information of the appropriate ID (step S105: No), the personal terminal 10 notifies an error (step S104), and returns to the processing of step S101. At this time, the personal terminal 10 can refer to not only the storage unit in the personal terminal 10 but also the storage unit of the work terminal 20 and an external database such as the confidential information database 30.

In a case where the decryption of the decryption information has been successful (step S106: Yes), the personal terminal 10 proceeds to the processing of step S107. On the other hand, in a case where the decryption of the decryption information has failed (step S106: No), the personal terminal 10 notifies an error (step S104), and returns to the processing of step S101.

In a case where the appropriate ID marker M is displayed on the screen (step S107: Yes), the personal terminal 10 reproduces sound corresponding to the display position of the appropriate ID (step S108), and terminates the processing. At this time, the personal terminal 10 confirms whether the ID marker M has been scroll-out or has jumped to another page. On the other hand, in a case where the appropriate ID marker M is not displayed on the screen (step S107: No), the personal terminal 10 returns to the processing of step S101.

### 3-1-2. Flow of Sound Reproduction Processing 2

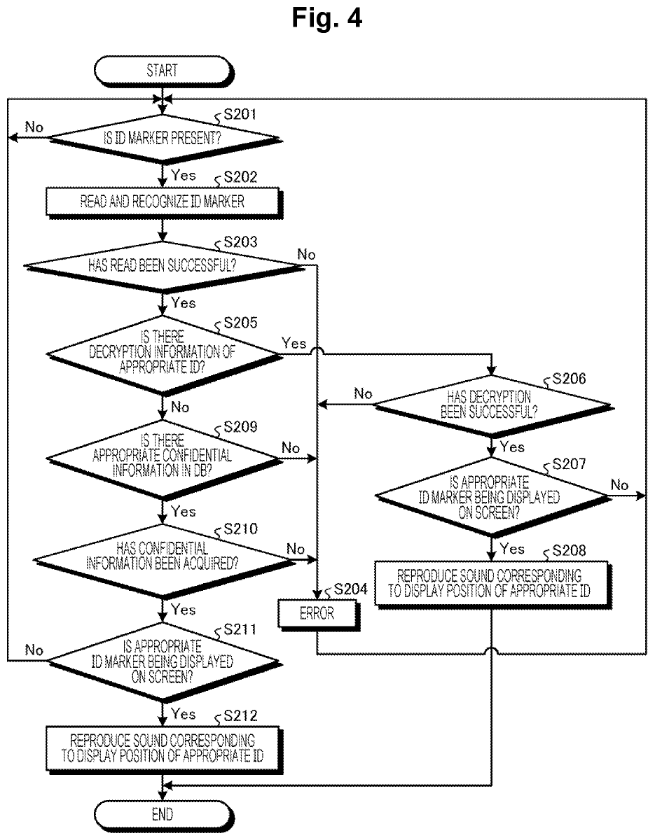

A flow of sound reproduction processing 2 of the personal terminal 10 in the sound reproduction system 100 will be described with reference to FIG. 4. Here, the sound reproduction processing 2 of the personal terminal 10 is processing of reading the ID marker M, acquiring the confidential information S associated with the ID marker M from the confidential information database 30, and executing sound reproduction. Note that steps S201 to S212 below can be executed in different orders. Furthermore, there may be omitted processing among steps S201 to S212 below.

In the case where the ID marker M is present on the screen of the work terminal 20 (step S201: Yes), the personal terminal 10 reads the ID marker M, executes the image recognition processing (step S202), and proceeds to the processing of step S203. On the other hand, in a case where there is no ID marker M on the screen of the work terminal 20 (step S201: No), the personal terminal 10 repeats the processing of step S201.

In a case where the read of the ID marker M has been successful (step S203: Yes), the personal terminal 10 proceeds to the processing of step S205. On the other hand, in a case where the read of the ID marker M has failed (step S203: No), the personal terminal 10 notifies an error (step S204), and returns to the processing of step S201.

In the case where the decryption information of the appropriate ID is present (step S205: Yes), the decryption of the decryption information has been successful (step S206: Yes), and the appropriate ID marker M is displayed on the screen (step S207: Yes), the personal terminal 10 reproduces sound corresponding to the display position of the appropriate ID (step S208), and terminates the processing. Note that steps S201 to S208 described above are processing common to steps S101 to S108 in the flow of the above-described sound reproduction processing 1. On the other hand, in the case where there is no decryption information of the appropriate ID (step S205: No), the personal terminal 10 moves onto processing of step S209.

In a case where there is the appropriate confidential information S in the confidential information database 30 (step S209: Yes), the personal terminal 10 proceeds to the processing of step S210. On the other hand, in a case where there is no appropriate confidential information S in the confidential information database 30 (step S209: No), the personal terminal 10 notifies an error (step S204), and returns to the processing of step S201.

In a case of acquiring the confidential information S from the confidential information database 30 (step S210: Yes), the personal terminal 10 proceeds to the processing of step S211. On the other hand, in a case of not acquiring the confidential information S from the confidential information database 30 (step S210: No), the personal terminal 10 notifies an error (step S204), and returns to the processing of step S201.

In the case where the appropriate ID marker M is displayed on the screen (step S211: Yes), the personal terminal 10 reproduces sound corresponding to the display position of the appropriate ID (step S212), and terminates the processing. On the other hand, in the case where the appropriate ID marker M is not displayed on the screen (step S211: No), the personal terminal 10 returns to the processing of step S201.

### 3-1-3. Flow of Sound Reproduction Processing 3

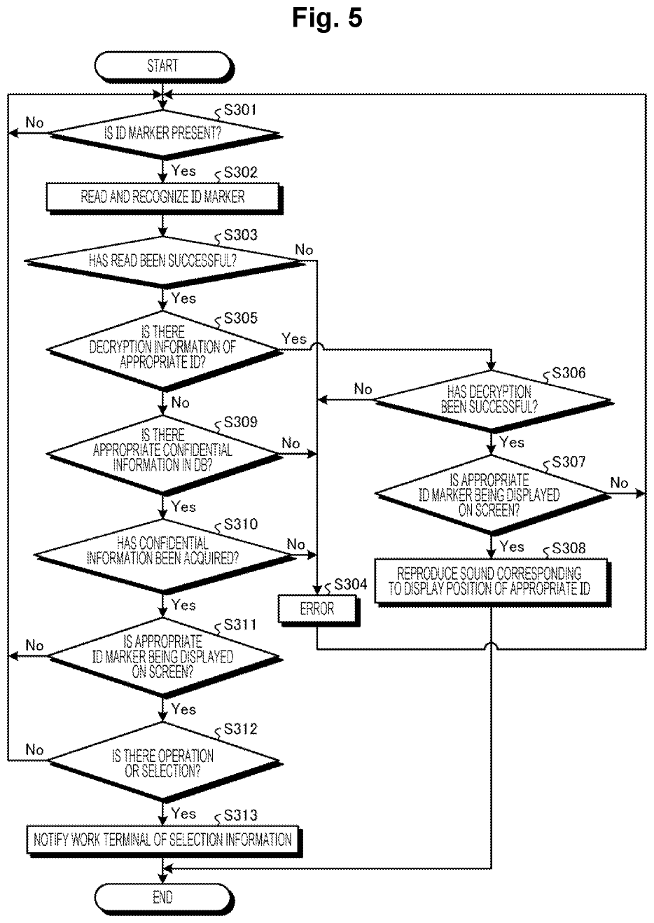

A flow of sound reproduction processing 3 of the personal terminal 10 in the sound reproduction system 100 will be described with reference to FIG. 5. Here, the sound reproduction processing 3 of the personal terminal 10 is processing of reading the ID marker M, acquiring the confidential information S associated with the ID marker M from the confidential information database 30, executing sound reproduction, and then inputting a sound reply to the selection information included in the confidential information S. Note that steps S301 to S313 below can be executed in different orders. Furthermore, there may be omitted processing among steps S301 to S313 below.

In the case where the ID marker M is present on the screen of the work terminal 20 (step S301: Yes), the personal terminal 10 reads the ID marker M, executes the image recognition processing (step S302), and proceeds to the processing of step S303. On the other hand, in the case where there is no ID marker M on the screen of the work terminal 20 (step S301: No), the personal terminal 10 repeats the processing of step S301.

In the case where the read of the ID marker M has been successful (step S303: Yes), the personal terminal 10 proceeds to the processing of step S305. On the other hand, in the case where the read of the ID marker M has failed (step S303: No), the personal terminal 10 notifies an error (step S304), and returns to the processing of step S301.

In the case where the decryption information of the appropriate ID is present (step S305: Yes), the decryption of the decryption information has been successful (step S306: Yes), and the appropriate ID marker M is displayed on the screen (step S307: Yes), the personal terminal 10 reproduces sound corresponding to the display position of the appropriate ID (step S308), and terminates the processing. Note that steps S301 to S308 described above are processing common to steps S101 to S108 in the flow of the sound reproduction processing 1 and steps S201 to S208 in the flow of the sound reproduction processing 2 described above. On the other hand, in the case where there is no decryption information of the appropriate ID (step S305: No), the personal terminal 10 moves onto processing of step S309.

In the case where there is the appropriate confidential information S in the confidential information database 30 (step S309: Yes), the personal terminal 10 proceeds to the processing of step S310. On the other hand, in the case where there is no appropriate confidential information S in the confidential information database 30 (step S309: No), the personal terminal 10 notifies an error (step S304), and returns to the processing of step S301.

In the case of acquiring the confidential information S from the confidential information database 30 (step S310: Yes), the personal terminal 10 proceeds to the processing of step S311. On the other hand, in the case of not acquiring the confidential information S from the confidential information database 30 (step S310: No), the personal terminal 10 notifies an error (step S304), and returns to the processing of step S301.

In the case where the appropriate ID marker M is displayed on the screen (step S311: Yes), the personal terminal 10 proceeds to the processing of step S312. On the other hand, in the case where the appropriate ID marker M is not displayed on the screen (step S311: No), the personal terminal 10 returns to the processing of step S301. Note that steps S301 to S311 described above are processing common to steps S201 to S211 in the flow of the sound reproduction processing 2 described above.

In a case where there is an operation, selection, or the like for the ID marker M (step S312: Yes), the personal terminal 10 notifies the work terminal 20 of the selection information (step S313), and terminates the processing. On the other hand, in a case where there is no operation, selection, or the like for the ID marker M (step S312: No), the personal terminal 10 returns to the processing of step S301.

### 3-2. Flow of Processing of Work Terminal 20

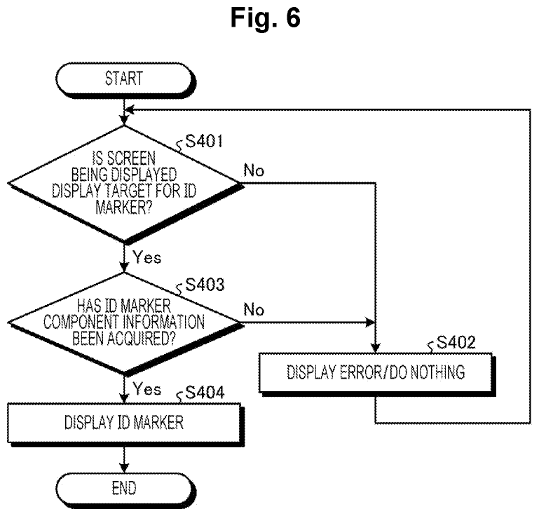

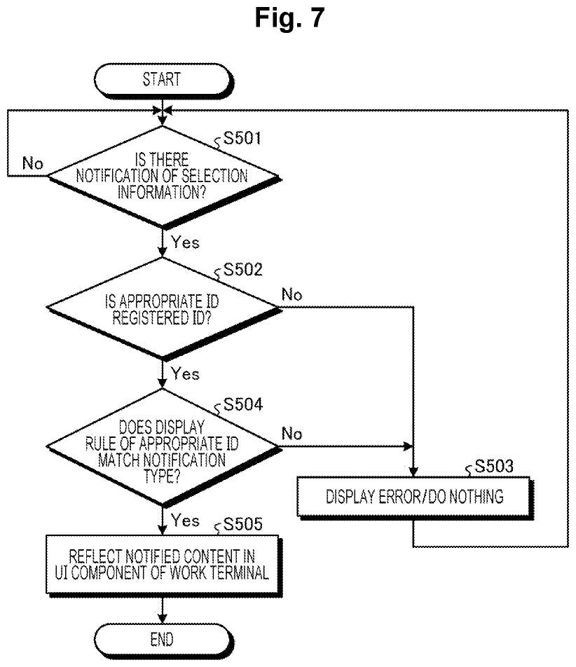

A flow of processing of the work terminal 20 in the sound reproduction system 100 will be described with reference to FIGS. 6 and 7. Hereinafter, a flow of ID marker display processing and a flow of selection information reflection processing will be described in this order.

### 3-2-1. Flow of ID Marker Display Processing

A flow of ID marker display processing of the work terminal 20 in the sound reproduction system 100 will be described with reference to FIG. 6. FIG. 6 is a flowchart illustrating an example of a flow of the ID marker display processing of the work terminal 20 according to the first embodiment. Here, the ID marker display processing of the work terminal 20 is processing of displaying the ID marker M on the screen of the personal terminal 10 prior to the sound reproduction processing 1, the sound reproduction processing 2, and the sound reproduction processing 3 of the work terminal 20 described above. Note that steps S401 to S404 below can be executed in different orders. Furthermore, there may be omitted processing among steps S401 to S404 below.

In a case where the screen being displayed on the work terminal 20 is a display target for the ID marker M (step S401: Yes), the work terminal 20 proceeds to the processing of step S403. On the other hand, in a case where the screen being displayed on the work terminal 20 is not the display target for the ID marker M (step S401: No), the work terminal 20 does display an error or does not execute the processing (step S402), and returns to the processing of step S401.

In a case of acquiring component information of the ID marker M (step S403: Yes), the work terminal 20 displays the ID marker M on the screen (step S404), and terminates the processing. On the other hand, in a case of not acquiring the component information of the ID marker M (step S403: No), the work terminal 20 does display an error or does not execute the processing (step S402), and returns to the processing of step S401.

### 3-2-2. Flow of Selection Information Reflection Processing

A flow of selection information reflection processing of the work terminal 20 in the sound reproduction system 100 will be described with reference to FIG. 7. FIG. 7 is a flowchart illustrating an example of a flow of selection information reflection processing of the work terminal according to the first embodiment. Here, the selection information reflection processing of the work terminal 20 is processing of reflecting the selection information in the UI component of the work terminal 20 after notification of the selection information by the sound reproduction processing 3 of the personal terminal 10 described above (see step S313 in FIG. 5). Note that steps S501 to S505 below can be executed in different orders. Furthermore, there may be omitted processing among steps S501 to S505 below.

In a case where there is notification of the selection information from the personal terminal 10 (step S501: Yes), the work terminal 20 proceeds to the processing of step S502. On the other hand, in a case where there is no notification of the selection information from the personal terminal 10 (step S501: No), the work terminal 20 repeats the processing of step S501.

In a case where an appropriate ID is a registered ID (step S502: Yes), the work terminal 20 proceeds to the processing of step S504. On the other hand, in a case where the appropriate ID is not a registered ID (step S502: No), the work terminal 20 does display an error or does not execute the processing (step S503), and returns to the processing of step S501.

In a case where the display rule of the appropriate

ID matches a notification type (step S504: Yes), the work terminal 20 reflects notified content in the UI component of the work terminal 20 (step S505), and terminates the processing. On the other hand, in a case where the display rule of the appropriate ID and the notification type do not match (step S504: No), the work terminal 20 does display an error or does not execute the processing (step S503), and returns to the processing of step S501.

### 4. Effects of First Embodiment

Finally, effects of the first embodiment will be described. Hereinafter, effects 1 to 4 corresponding to the processing according to the first embodiment will be described.

### 4-1. Effect 1

In the above-described first embodiment, the display information displayed as a UI component is acquired, the target information regarding the target to be reproduced as sound is specified on the basis of the identification information indicated by the display information, and the target information is reproduced as sound. That is, in the first embodiment, in the UI extension technology, the confidential information S is read by a specific reading device such as the smart glasses 10A, and the confidential information S is reproduced by a sound reproduction device such as the headphone 10B. Therefore, the first embodiment enables effective use of the UI extension technology.

### 4-2. Effect 2

In the above-described first embodiment, the display information including the encrypted target information is acquired, the encrypted target information is decrypted, and the decrypted target information is reproduced as sound. That is, in the first embodiment, in the UI extension technology, the confidential information S is displayed as the ID marker M that can be decrypted only by the reading device such as the smart glasses 10A, and is read and decrypted by the reading device, so that the confidential information S is reproduced by the sound reproduction device such as the headphone 10B. Therefore, the first embodiment enables effective use of the UI extension technology by acquiring the encrypted confidential information S.

### 4-3. Effect 3

In the above-described first embodiment, the storage area for storing the target information is specified on the basis of the identification information indicated by the display information, and the target information stored in the specified storage area is reproduced as sound. That is, in the UI extension technology, the confidential information S is displayed as the appropriate ID marker M and is read by a specific reading device such as the smart glasses 10A, the confidential information S of the appropriate ID is taken out from an arbitrary storage device such as the confidential information database 30, and sound is reproduced by a sound reproduction device such as the headphone 10B. Therefore, the first embodiment enables effective use of the UI extension technology by acquiring the encrypted confidential information S on the basis of the ID information.

### 4-4. Effect 4

In the above-described first embodiment, the sound reply to the target information is reflected on the UI component. That is, in the first embodiment, to perform the selection operation, the UI component and a specific input device such as the microphone 10C are linked, and the input information by sound is distributed between terminals, in addition to the above-described sound reproduction of the confidential information S. Therefore, the first embodiment enables effective use of the UI extension technology by reflecting the reply to the confidential information S on the basis of the sound information.

### System Configuration and the Like

Each component of each device illustrated according to the above embodiments is functionally conceptual and does not necessarily have to be physically configured as illustrated. That is, a specific form of distribution and integration of each device is not limited to the illustrated form, and all or a part thereof can be functionally or physically distributed and integrated in any unit according to various loads, usage conditions, and the like. Furthermore, all or any part of the processing functions performed in each device can be implemented by a CPU and a program analyzed and executed by the CPU, or can be implemented as hardware by wired logic.

Furthermore, among the processing described in the above embodiments, all or a part of the processing described as being automatically performed can be manually performed, or all or a part of the processing described as being manually performed can be automatically performed by a known method. In addition, the processing procedures, the control procedures, the specific names, and the information including various data and parameters illustrated in the above document and drawings can be arbitrarily changed unless otherwise specified.

### Program

In addition, it is also possible to create a program in which the processing executed by the personal terminal 10 described in the foregoing embodiment is described in a language that can be executed by a computer. In this case, the computer executes the program, and thus the effects similar to those of the above embodiments can be obtained. Furthermore, the program may be recorded in a computer-readable recording medium, and the program recorded in the recording medium may be read and executed by the computer to implement processing similar to that of the above embodiments.

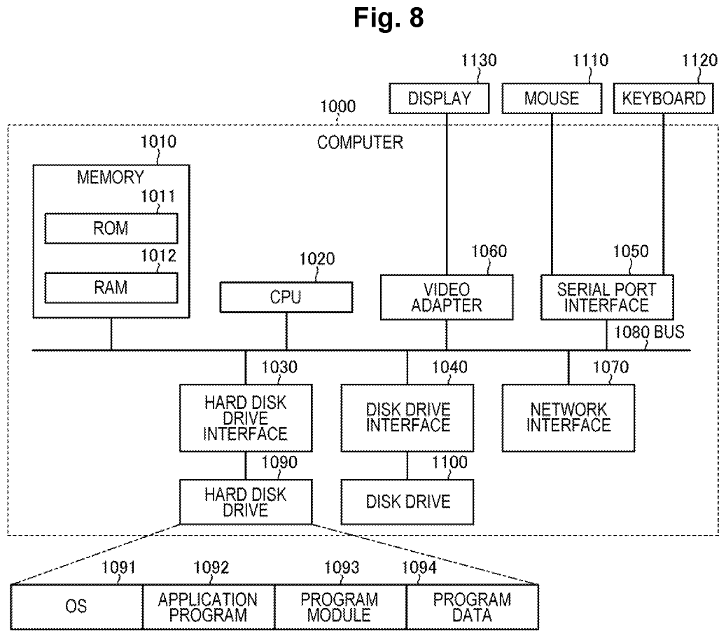

FIG. 8 is a diagram illustrating a computer that executes a program. As illustrated in FIG. 8, a computer 1000 includes, for example, a memory 1010, a CPU 1020, a hard disk drive interface 1030, a disk drive interface 1040, a serial port interface 1050, a video adapter 1060, and a network interface 1070, and these units are connected by a bus 1080.

As exemplified in FIG. 8, the memory 1010 includes a read only memory (ROM) 1011 and a RAM 1012. The ROM 1011 stores, for example, a boot program such as a basic input output system (BIOS). The hard disk drive interface 1030 is connected to a hard disk drive 1090 as illustrated in FIG. 8. The disk drive interface 1040 is connected to a disk drive 1100 as illustrated in FIG. 8. For example, a removable storage medium such as a magnetic disk or an optical disk is inserted into the disk drive 1100. As illustrated in FIG. 8, the serial port interface 1050 is connected to, for example, a mouse 1110 and a keyboard 1120. As exemplified in FIG. 8, the video adapter 1060 is connected to, for example, a display 1130.

Here, as exemplified in FIG. 8, the hard disk drive 1090 stores, for example, an OS 1091, an application program 1092, a program module 1093, and program data 1094. That is, the above program is stored as a program module in which a command executed by the computer 1000 is described, for example, in the hard disk drive 1090.

In addition, various data described in the above embodiments is stored as program data in, for example, the memory 1010 and the hard disk drive 1090. The CPU 1020 then reads the program module 1093 and the program data 1094 stored in the memory 1010 and the hard disk drive 1090 to the RAM 1012 as necessary, and executes various processing procedures.

Note that the program module 1093 and the program data 1094 related to the program are not limited to being stored in the hard disk drive 1090, and may be stored in, for example, a removable storage medium and read by the CPU 1020 via the disk drive or the like. Alternatively, the program module 1093 and the program data 1094 related to the program may be stored in another computer connected via a network (such as a local area network (LAN) or a wide area network (WAN)) and read by the CPU 1020 via the network interface 1070.

The embodiment described above and modifications thereof are included in the invention described in the claims and the scope of equivalents thereof similarly to being included in the technique disclosed in the present application.

### REFERENCE SIGNS LIST

10 Personal terminal (sound reproduction device)
10A Smart glasses
10B Headphone
10C Microphone
11, 21 communication unit
12, 22 Input unit
13, 23 Output unit
14, 24 Storage unit
15, 25 Control unit
15a Acquisition unit
15b Specifying unit
15c Decryption unit
15d Reproduction unit
15e Reflection unit
20 Work terminal
25a Display unit
30 Confidential information database
100 Sound reproduction system

1. A sound reproduction device comprising a processor configured to execute operations comprising:
acquiring display information displayed as a user interface (UI) component;
specifying target information, wherein the target information specifies a target to be reproduced as sound on the basis of identification information indicated by the display information; and
reproducing the target information as sound.

2. The sound reproduction device according to claim 1, wherein
the acquiring further comprising acquiring the display information including the target information in encrypted form,
the acquiring further comprises decrypting the target information in encrypted form, and
the reproducing further comprises reproducing the decrypted target information as sound.

3. The sound reproduction device according to claim 1, wherein the specifying further comprises specifying a storage area for storing the target information on the basis of the identification information indicated by the display information, and
the reproducing further comprises reproducing the target information stored in the specified storage area as sound.

4. The sound reproduction device according to claim 1, the processor further configured to execute operations comprising:
reflecting a reply by sound to the target information on the UI component.

5. A computer-implemented method for reproducing sound, comprising:
an acquisition step of acquiring display information displayed as a UI component;
a specifying step of specifying target information, wherein the target information specifies a target to be reproduced as sound on the basis of identification information indicated by the display information; and
a reproduction step of reproducing the target information as sound.

6. A computer-readable non-transitory recording medium storing a computer-executable program instructions that when executed by a processor cause a computer to execute operations comprising:
acquiring display information displayed as a UI component;
specifying target information, wherein the target information specifies a target to be reproduced as sound on the basis of identification information indicated by the display information; and
reproducing the target information as sound.

7. The sound reproduction device according to claim 1, the processor further configured to execute operations comprising:
retrieving, based on the identification information, the target information from a confidential information database, wherein the confidential information database stores confidential information as represented by the target information, and the target information comprises sound.

8. The sound reproduction device according to claim 1, wherein the display information comprises a marker identifier of the target to prevent from displaying the target in unencrypted form, and the target represents secret information.

9. The sound reproduction device according to claim 1, wherein the display information comprises codified information identifying the target.

10. The computer-implemented method according to claim 5, wherein
the acquiring further comprising acquiring the display information including the target information in encrypted form,
the acquiring further comprises decrypting the target information in encrypted form, and
the reproducing further comprises reproducing the decrypted target information as sound.

11. The computer-implemented method according to claim 5,
wherein the specifying further comprises specifying a storage area for storing the target information on the basis of the identification information indicated by the display information, and
the reproducing further comprises reproducing the target information stored in the specified storage area as sound.

12. The computer-implemented method according to claim 5, further comprising:
reflecting a reply by sound to the target information on the UI component.

13. The computer-implemented method according to claim 5, further comprising:
retrieving, based on the identification information, the target information from a confidential information database, wherein the confidential information database stores confidential information as represented by the target information, and the target information comprises sound.

14. The computer-implemented method according to claim 5, wherein the display information comprises a marker identifier of the target to prevent from displaying the target in unencrypted form, and the target represents secret information.

15. The computer-implemented method according to claim 5, wherein the display information comprises codified information identifying the target.

16. The computer-readable non-transitory recording medium according to claim 6, wherein
the acquiring further comprising acquiring the display information including the target information in encrypted form,
the acquiring further comprises decrypting the target information in encrypted form, and
the reproducing further comprises reproducing the decrypted target information as sound.

17. The computer-readable non-transitory recording medium according to claim 6,
wherein the specifying further comprises specifying a storage area for storing the target information on the basis of the identification information indicated by the display information, and
the reproducing further comprises reproducing the target information stored in the specified storage area as sound.

18. The computer-readable non-transitory recording medium according to claim 6, the computer-executable program instructions when executed further causing the computer to execute operations comprising:
reflecting a reply by sound to the target information on the UI component.
